(19) United States
(12) Patent Application Publication
(10) Pub. No.: US 2021/0009256 A1
(43) Pub. Date: Jan. 14, 2021

(54) ELLIPTICAL WING TIP AND METHOD OF FABRICATING SAME

(71) Applicants: Eric A. AHLSTROM, South Willard, UT (US); AERO DESIGN LABS, INC., Ft. Worth, TX (US)

(72) Inventor: Eric A. AHLSTROM, South Willard, UT (US)

(21) Appl. No.: 17/041,607

(22) PCT Filed: Apr. 1, 2019
(86) PCT No.: PCT/US2019/025154

§ 371 Date: Sep. 25, 2020

Related U.S. Application Data
(60) Provisional application No. 62/651,412, filed on Apr. 2, 2018.

(51) Int. Cl. B64C 23/06; B64C 11/18; B64C 27/46; B64C 3/14; B64C 5/02; B64F 5/10

(52) U.S. Cl. CPC B64C 23/065; B64C 11/18; B64C 27/463; B64C 2003/142; B64C 5/02; B64F 5/10; B64C 3/14

(57) ABSTRACT

A wingtip of a lifting surface of an aeronautical vehicle, the lifting surface having a span, a leading edge, a trailing edge, an upper surface and a lower surface, the wingtip being in a range of five percent to fifteen percent of an end portion of the span of the lifting surface, the wingtip including: an elliptical shape between the leading and trailing edges, the elliptical shape tapering in a direction towards an outer edge of the wing tip, wherein the tapering occurs in a plurality of geometric parameters of the lifting surface including spanwise chord distribution between the leading and trailing edges, spanwise mean camber distribution between the leading including and trailing edges, spanwise maximum thickness between the upper and lower surfaces, and spanwise twist of a mean average of the spanwise chord distribution of the wingtip.

### CROSS-REFERENCE TO RELATED APPLICATION

This patent application claims priority to U.S. provisional Application No. 62/651,412, filed Apr. 2, 2018, the content of which is incorporated by reference herein in its entirety.

### FIELD OF INVENTION

The invention relates to aeronautical lifting surfaces, and more specifically to a wing tip of a wing of an aircraft.

### BACKGROUND OF INVENTION

Commercial aircraft cabins are pressurized and, therefore, the fuselage is cylindrical in shape to accommodate the loads of pressurization with minimal structural weight. The wing structure and many accessory systems protrude outside the contour of the round fuselage and typically require fairings to maintain streamlined airflow around these systems which, by the nature of their mechanics and physical characteristics, are not necessarily cylindrical in shape.

Wingtip devices of a wide variety are used on the lifting surfaces of aircraft. Lifting surfaces include main wings, lifting stabilizers, lifting canards, helicopter rotor blades, and vertical or partially vertical winglet devices. All of these lifting surfaces can be referred to as “wing surfaces” for the description of this invention. Wingtip devices have a great deal of influence on the induced and parasitic drag of the wing surface they are attached to. Wingtip devices are generally understood to comprise the outer 5% to 15% of the combined span of the wing surface and wingtip device, i.e., the wing span from the root chord to tip chord.

Wingtip devices are often contoured in a number of different ways. Upswept or vertical winglets, aft swept wingtips, split wingtips, and many other designs are used in an effort to manipulate the wingtip vortex. This vortex is a natural consequence of the interface between the air that the wing travels through and the adjacent air.

The location and strength of the wingtip vortex relative to the wing surface has a large effect on induced drag and the spanwise distribution of lift. A strong wingtip vortex rotates the normal force vector of the wing surface aft. It is the vertical component of the normal force vector that defines lift, while the aft component defines induced drag, or drag due to lift. The location the wingtip vortex also influences the induced drag. Wingtip devices that allow the wingtip vortex to form forward or inboard lead to higher induced drag, while devices that move the wingtip vortex aft, up, down, or a combination of these reduce the influence of the vortex on the rotation of the normal force vector and induced drag.

U.S. Pat. No. 5,348,253 discloses vertical winglets that move the wingtip vortex up and aft, reducing induced drag at some expense of parasitic drag. Vertical winglets also move the spanwise lift distribution outboard. This increases the bending moment on the wing surface. The vertical winglet adds significant structural weight to resist this bending moment, additional lift, and resist flutter due to the concentration of mass at the maximum span of the wing. This additional weight adds to the empty weight of the aircraft and reduces payload for a given gross takeoff weight. While the winglet may reduce induced drag and fuel burn, range may not increase in proportion due to the negative impact of the increase in aircraft empty weight. Twist, camber, and thickness distribution are not sufficient to prevent the wingtip system generating lift at the tip leading to vortex flow on the wingtip. That is, even if the twist, camber and thickness characteristics are zero, lift will still be present at the wing tips.

A Scimitar wing tip is unlike other wingtip designs in that its purpose and effect is not to make lift, but to induce the inboard portion of the wing to make more lift while the tip makes less lift. This movement of the lift distribution inboard reduces the outboard span load for any lift condition or wing angle of attack, i.e., wing alpha.

For example, split wingtips as disclosed in U.S. Pat. No. 8,944,386 divide the wingtip vortex into two separate vortices, extending from the upper and lower wingtip extensions. These vortices combine to induce a counter rotating vortex between the two tip vortices downstream of the wingtip system. The split wingtip can lead to more outboard spanwise lift distribution, leading to additional structural weight and tradeoff between fuel consumption and payload. Twist, camber, and thickness distribution are not sufficient to prevent the wingtip system from generating lift at the tip, which in turn leads to vortex flow on the wingtip instead of behind it.

Raked wingtips as disclosed in U.S. Pat. Nos. 5,039,032 and 6,089,502 are devices that increase the span of the wing while attempting to reduce wing bending through reducing the chord in length a linear manner. Conventional raked wingtips do not adequately address thickness, camber, and twist distribution and, therefore, still suffer from the wingtip system generating lift at the tip which leads to vortex flow on the wingtip.

U.S. Pat. No. 8,544,800 discloses an integrated wingtip extension includes a tapered wing section and a winglet. The tapered wing section includes an inboard end portion having a first chord length and an outboard end portion having a second chord length that is less than the first chord length. The winglet is fixedly attached to the outboard end portion. The inboard end portion is configured to be fixedly attached to a tip portion of an aircraft wing. Alternatively, the tapered wing section and the winglet can be integrally formed from composite materials. The disadvantages of the winglet extension is that it generates lift at the tip and aft of the elastic axis of the wing structure. This phenomena increases wing bending moment and torsional loads requiring more structural weight, which offsets some or much of the theoretical fuel savings.

Elliptically swept tips as disclosed in U.S. Pat. No. 9,381,999 do not adequately address thickness, camber, and twist distribution and, therefore, still suffer from the wingtip system generating lift at the tip which leads to vortex flow on the wingtip.

The practice of including a winglet at the ends of the wings is a well-known practice that has been mostly unchanged in previous commercial aircraft design, and is known to significantly reduce the drag created by lift and vortices occurring at the wing tips at the expense of increased structural weight and parasitic drag. In view of the aforementioned and other deficiencies in the prior art, it is desirable to provide an elliptical wingtip that minimizes lift at the wing tips and thereby reduce the size and effect of the wingtip vortices at the wingtips of the wing.

### SUMMARY OF THE INVENTION

The above disadvantages and deficiencies in the prior art are avoided and/or solved by various embodiments of an elliptical shaped wing tip on a wing of an aircraft. The wingtip corresponds to a lifting surface of an aeronautical vehicle, in which the lifting surface has a span, a leading edge, a trailing edge, an upper surface and a lower surface, and the wingtip is in a range of five percent to fifteen percent of an end portion of the span of the lifting surface. The wingtip includes an elliptical shape between the leading and trailing edges, the elliptical shape tapering in a direction towards an outer edge of the wing tip, wherein the tapering occurs in a plurality of geometric parameters of the lifting surface including spanwise chord distribution between the leading and trailing edges, spanwise mean camber distribution between the leading and trailing edges, spanwise maximum thickness between the upper and lower surfaces, and spanwise twist of a mean average of the spanwise chord distribution of the wingtip.

In one embodiment there is provided, a wingtip of an airfoil of an aircraft, the airfoil having a span, a leading edge, a trailing edge, an upper surface and a lower surface, the wingtip being in a range of five percent to fifteen percent of an end portion of the span of the airfoil, the wingtip comprising: an elliptical shape between the leading and trailing edges, the elliptical shape tapering in a direction towards an outer edge of the wing tip, wherein the tapering of the wingtip occurs in four geometric parameters including spanwise chord distribution between the leading and trailing edges, spanwise mean camber distribution between the leading and trailing edges, spanwise maximum thickness between the upper and lower surfaces, and spanwise twist of a mean average of the spanwise chord distribution of the wingtip; and wherein the chord length is tapered in a range of 0.45 to 0.50 of the initial chord at 100% span, the mean camber distribution tapers to zero at 100% span, a thickness to chord ratio tapers to less than one percent at 100% span, and twist of a mean chord distribution of the span of the wingtip is in a range of negative one degree and negative three degrees at 100% span relative to the innermost airfoil of the wingtip in a direction of a positive lift axis.

In another embodiment there is provided a wingtip of a lifting surface of an aeronautical vehicle, the lifting surface having a span, a leading edge, a trailing edge, an upper surface and a lower surface, the wingtip being in a range of five percent to fifteen percent of an end portion of the span of the lifting surface, the wingtip comprising: an elliptical shape between the leading and trailing edges, the elliptical shape tapering in a direction towards an outer edge of the wing tip, wherein the tapering occurs in a plurality of geometric parameters of the lifting surface including spanwise chord distribution between the leading and trailing edges, spanwise mean camber distribution between the leading and trailing edges, spanwise maximum thickness between the upper and lower surfaces, and spanwise twist of a mean average of the spanwise chord distribution of the wingtip.

In one aspect, the trailing edge of the lifting surface is constant. In a further aspect, the chord length is tapered in a range of 0.35 to 0.60 of the initial chord at 100% span. In still a further aspect, the chord length is tapered in a range of 0.45 to 0.50 of the initial chord at 100% span.

In another aspect, the trailing edge of the lifting surface is tapered. In a further aspect, the chord length is tapered in a range of 0.35 to 0.60 of the initial chord at 100% span. In still a further aspect, the chord length is tapered in a range of 0.45 to 0.50 of the initial chord at 100% span.

In one aspect, the mean camber distribution tapers to zero at 100% span. In another aspect, a thickness to chord ratio tapers to less than one percent at 100% span. In still another aspect, the spanwise twist of a mean average of the spanwise chord distribution of the wingtip is in a range of negative one degree and negative three degrees at 100% span relative to the innermost airfoil of the wingtip in a direction of a positive lift axis.

In one aspect, the wingtip is configured for installation on one of a BOEING model 737 NG-700, 737 NG-800, and 737 NG-900 aircraft. In another aspect, the wingtip is configured for installation on one of a BOEING model 737 MAX-7, 737 MAX-8, 737 MAX-9, and 737 MAX-10 aircraft. In yet another aspect, the wingtip is configured for installation on a main wing of an aircraft. In still another aspect, the wingtip is configured for installation on a horizontal stabilizer of an aircraft. In a further aspect, the wingtip is configured for installation on a canard of an aircraft. In still a further aspect, the wingtip is configured for installation on rotor blade of a helicopter. In another aspect, the wingtip is configured for installation on a blade of a propeller.

In yet another embodiment, a method of fabricating wingtip of a lifting surface of an aeronautical vehicle, the lifting surface including a span, and an elliptical shape defined by a leading edge, a trailing edge, an upper surface and a lower surface, the method comprises the steps of: determining an outer portion of the lifting surface forming the wingtip; tapering the elliptical shape of the wingtip in a direction towards a distal end of the wingtip, said tapering including: tapering spanwise chord distribution between the leading and trailing edges, tapering spanwise mean camber distribution between the leading and trailing edges, tapering spanwise maximum thickness between the upper and lower surfaces, tapering spanwise twist of a mean average of the spanwise chord distribution of the wingtip; and forming the lifting surface with the elliptical tapered wingtip.

In one aspect, the step of determining an outer portion of the lifting surface forming the wingtip comprises determining a proximal end and the distal end of the wingtip, wherein the proximal end being located at an outer five percent to fifteen percent of the span of the lifting surface.

In another aspect, the method further comprises maintaining the trailing edge of the lifting surface constant. In a further aspect, the method further comprises tapering the chord length in a range of 0.35 to 0.60 of the initial chord at 100% span. In still a further aspect, the method further comprises tapering the chord length in a range of 0.45 to 0.50 of the initial chord at 100% span.

In yet another aspect, the method further comprises tapering the trailing edge of the lifting surface. In a further aspect, the method further comprises tapering the chord length in a range of 0.35 to 0.60 of the initial chord at 100% span. In still a further aspect, the method further comprises tapering the chord length in a range of 0.45 to 0.50 of the initial chord at 100% span. In yet another aspect, the method further comprises tapering the mean camber distribution to zero at 100% span. In still another aspect, the method further comprises tapering a thickness to chord ratio to less than one percent at 100% span. In yet a further aspect, the method further comprises tapering twist of a mean chord distribution of the span of the wingtip is in a range of negative one degree and negative three degrees at 100% span relative to the innermost airfoil of the wingtip in a direction of a positive lift axis.

In one aspect, the method further comprises configuring the lifting surface with the tapered wingtip for installation on one of a BOEING model 737 NG-700, 737 NG-800, and 737 NG-900 aircraft. In another aspect, the method further comprising configuring the lifting surface with the tapered wingtip for installation on one of a BOEING model 737 MAX-7, 737 MAX-8, 737 MAX-9, and 737 MAX-10 aircraft.

In one aspect the method further comprises configuring the lifting surface with the tapered wingtip for installation on a main wing of an aircraft. In another aspect the method further comprises configuring the lifting surface with the tapered wingtip for installation on a horizontal stabilizer of an aircraft. In still another aspect the method further comprises configuring the lifting surface with the tapered wingtip for installation on a canard of an aircraft. In yet another aspect the method further comprises configuring the lifting surface with the tapered wingtip for installation on rotor blade of a helicopter. In another aspect the method further comprises configuring the lifting surface with the tapered wingtip for installation on a blade of a propeller.

### BRIEF DESCRIPTION OF THE DRAWINGS

FIG. 1 depicts a top plan view of a right side horizontal stabilizer of a swept wing jet transport aircraft and illustrating an elliptical wingtip in accordance with the present invention;

FIG. 2 depicts a right side elevation view of the elliptical wing tip of FIG. 1 as viewed from a perspective of the trailing edge of the swept horizontal stabilizer;

FIG. 3 depicts a right side elevation view of the elliptical wing tip of the swept horizontal stabilizer of FIG. 1;

FIG. 4 depicts an exploded view of a first airfoil of the wingtip of FIG. 2 illustrating its chord line, mean camber line and maximum thickness;

FIG. 5 depicts a top, rear, right-side perspective view of the swept horizontal stabilizer and illustrating sectional views of the elliptical shape of the wing tip of FIG. 1;

FIG. 6 depicts a top, front, right-side perspective view of the swept horizontal stabilizer and illustrating the sectional views of the elliptical shape of the wing tip of FIG. 4;

FIG. 7 is a flow diagram of a method for fabricating a lifting surface of the present invention for an aeronautical vehicle;

FIG. 8A (prior art) and FIG. 8B are graphical images of a bottom, right-side view of wingtip of a wing of an aircraft without and with the elliptical shaped wingtip, respectively, and comparatively displaying computer simulations of high and low velocity surface air flow and turbulence over the wing and wingtip of the aircraft with and without the elliptical wingtip;

FIG. 9A (prior art) and FIG. 9B are graphical images of an enlarged, bottom, right-side view of wingtip of a wing of an aircraft of FIGS. 7A and 7B without and with the elliptical shaped wingtip, respectively, and comparatively displaying computer simulations of high and low velocity surface air flow and turbulence over the wing and wingtip of the aircraft with and without the elliptical wingtip; and

FIG. 10A (prior art) and FIG. 10B are graphical images of a top, right-side view of wingtip of a wing of an aircraft without and with the elliptical shaped wingtip, respectively, and comparatively displaying computer simulations of high and low velocity surface air flow and turbulence over the wing and wingtip of the aircraft with and without the elliptical wingtip;

To further facilitate an understanding of the invention, the same reference numerals have been used, when appropriate, to designate the same or similar elements that are common to the figures. Further, unless otherwise indicated, the features shown in the figures are not drawn to scale, but are shown for illustrative purposes only.

### DETAILED DESCRIPTION OF THE EMBODIMENTS

The present invention is directed to an elliptical shaped wingtip of a wing of an aircraft. In one embodiment, the elliptical wingtip preferably tapers at the outer five to fifteen percent of the combined wing surface and wingtip system. The elliptical tapering is provided across four geometric design parameters of the wing including chord distribution, mean camber distribution, wing thickness, and twist. The combined elliptical tapering across all four geometric parameters provides the advantageous effects of the elliptical wingtip that exceeds the prior art wingtip designs.

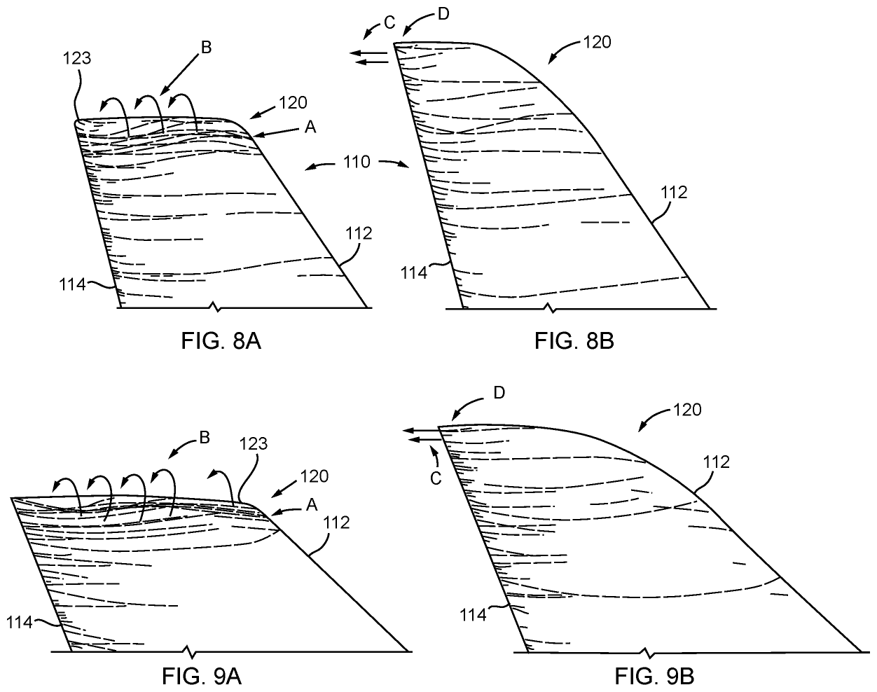

In particular, the elliptical wingtip has numerous effects on the wing surface. For example, the shape of the elliptical wingtip moves the initiation of the wingtip vortex to the most aft and outboard point on the wingtip. This is evidenced by straight streamlines at the 99% to 100% span area of the combined wing and wingtip, as discussed below with respect to FIGS. 8A-10B. This outer and aft-most positioning of the wingtip vortex leads to lower induced drag, while also producing less lift on the wingtip than observed on prior art wing/wingtip designs.

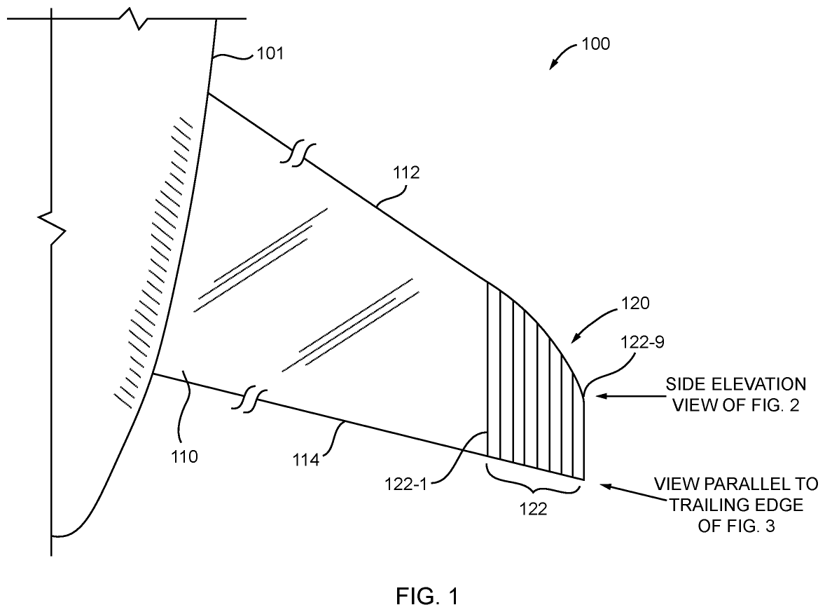

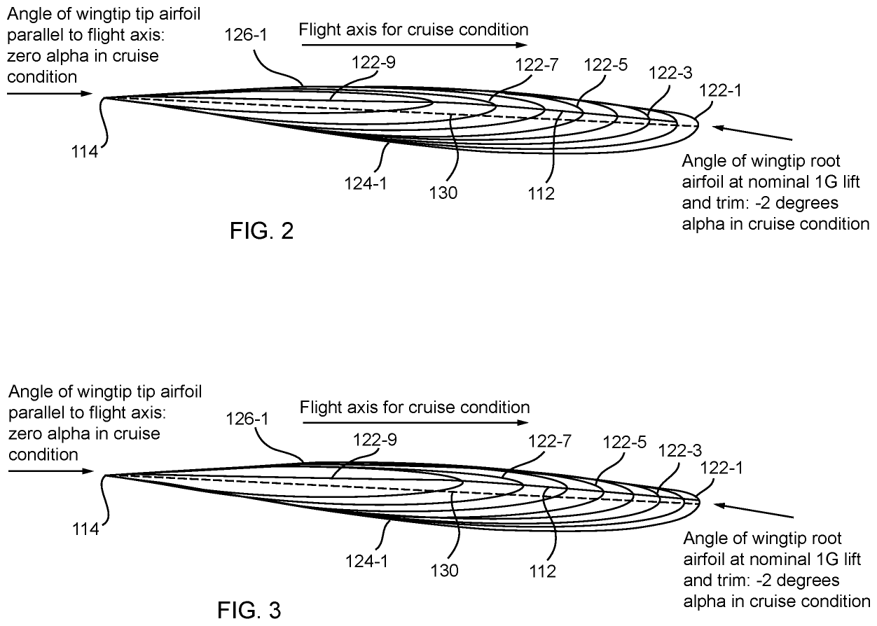

Referring to FIG. 1, a bottom view of a horizontal stabilizer 110 of an aircraft 100 is illustratively shown. The elliptical wingtip 120 is illustratively shown and discussed with respect to a horizontal stabilizer of an aircraft, but is not considered limiting. For example, the elliptical shape can be similarly provided on an aircraft wing, lifting stabilizer, lifting canard, helicopter rotor blade, winglet and other lifting surfaces. The horizontal stabilizer is attached to the fuselage 101 of the aircraft 100 and extends outwardly in a well-known manner. The horizontal stabilizer includes a leading edge 112, a trailing edge 114 and terminates at a wingtip 120 having an elliptical shape of the present invention. The wingtip includes the outer 5% to 15% of the combined span of the wing surface. The elliptical wingtip portion can be represented by a plurality of local airfoils or cross-sections 122, for example, nine cross-sections 122-1 through 122-9 as illustratively shown in FIG. 1. The elliptical taper of the airfoils 122 can best be seen in FIGS. 2-4.

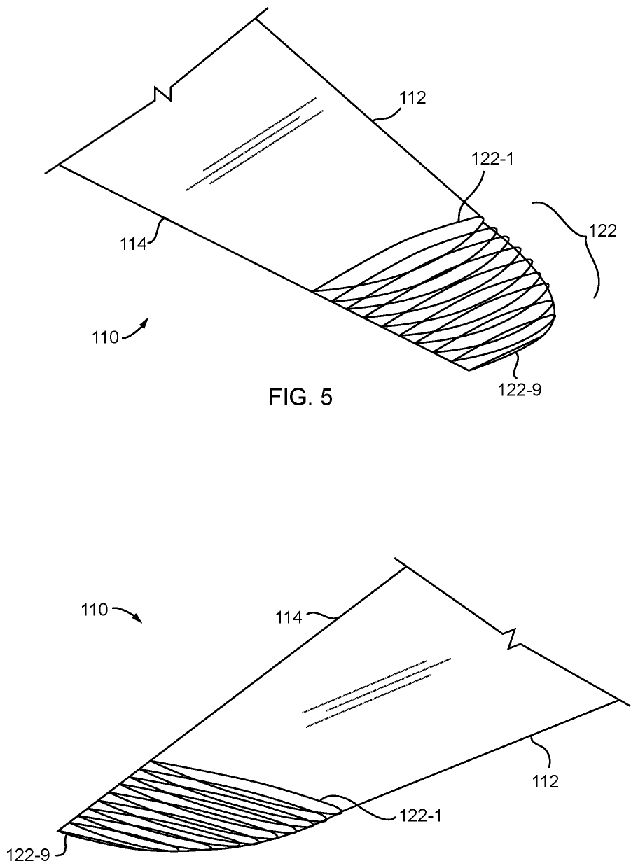

Referring now to FIGS. 2 and 3, the elliptical taper of the wingtip cross sections is illustratively shown. FIG. 2 depicts a side elevation view of the horizontal stabilizer 110, while FIG. 3 depicts an elevation view parallel to the trailing edge 114 of the horizontal stabilizer 110. The nine airfoils illustrate the diminishing curvature of the leading edge 112 of the elliptical wingtip with respect to the trailing edge 114 which is substantially linear, i.e., constant. Referring to FIG. 2, the first airfoil 122-1 defines the largest elliptical profile and the outermost airfoil 122-9 defines he smallest elliptical profile. The second through eighth elliptical profiles 122-2 through 122-9 are evenly spaced and define the leading edge curvature between the first and last airfoils 122-1, 122-9. The lower surface 124 of the wingtip 110 tapers upwardly in a lateral direction from the first airfoil 122-1 to the last airfoil 122-9, as best seen in FIG. 5. Similarly, the upper surface 126 of the wingtip 110 tapers downwardly in the lateral direction from the first airfoil 122-1 to the last airfoil 122-9, as best seen in FIG. 6.

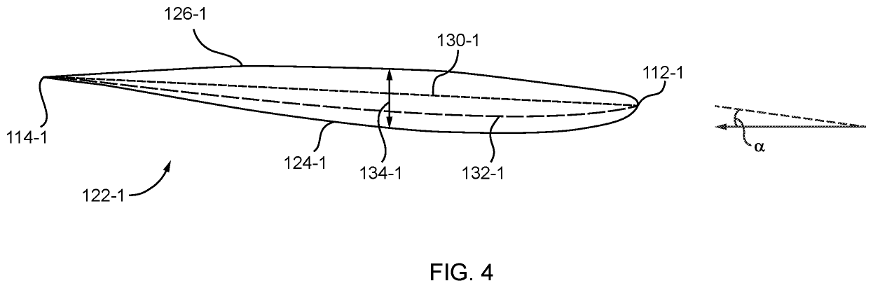

Referring to FIG. 4, a cross-sectional view of the first airfoil 122-1 of the tapered wingtip 110 is shown. It is well-known that an elliptic curve over a two dimensional field of quantities x and y consists of all the points that satisfy the following equation: 1=(x²/a²)+(y²/b²), where “a” is the elliptical radius on the x axis and “b” is the elliptical radius on the y axis and the curve does not have any singular points, i.e., no cusps or self-intersections.

The cross-sectional view illustrates the chord 130-1 and the mean camber line 132-1, both of which extend between the leading edge 112-1 and trailing edge 114-1 of the illustrative cross-section 122-1. The maximum thickness 134-1 of the wingtip at the cross-section 122-1 is also illustrated. Each of the other illustrative airfoils 122-2 through 122-9 have similar, but tapered characteristics, as shown in the elevation views of FIGS. 2 and 3 and the perspective top right-side views of FIGS. 5 and 6.

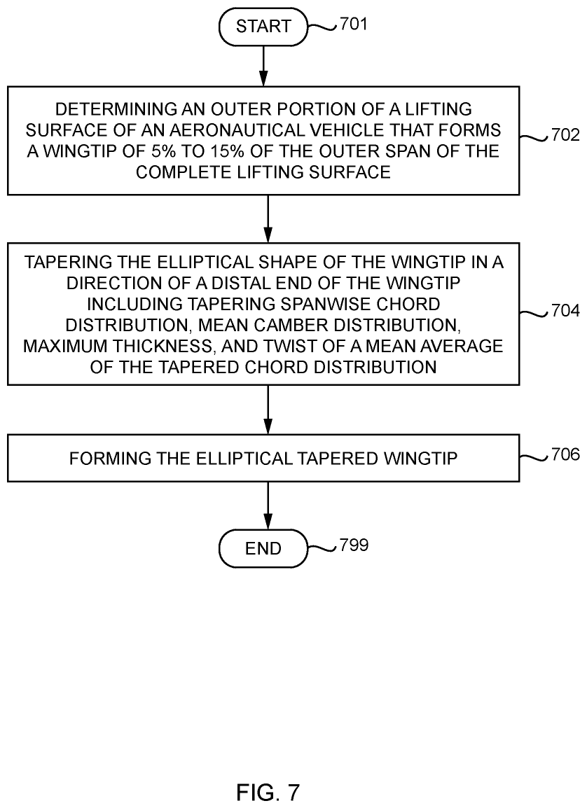

FIG. 7 is a flow diagram of a method 700 for fabricating a lifting surface of the present invention for an aeronautical vehicle. The method 700 starts at step 701, where the type of lifting surface is identified. For example, the lifting surface can be a wing, horizontal stabilizer, vertical stabilizer, or canard of an aircraft, or a blade of a helicopter or propeller, among other lifting surfaces. The method 700 then proceeds to step 702, where an outer portion of the lifting surface which forms the wingtip is determined. In one embodiment, the outer five percent to fifteen percent of the lifting surface forms the wingtip, although such percentages are not considered limiting.

At step 704, tapering of the elliptical shape of the wingtip in a direction towards a distal end of the wingtip is performed. The tapering includes tapering spanwise chord distribution between the leading and trailing edges, tapering spanwise mean camber distribution between the leading and trailing edges, tapering spanwise maximum thickness between the upper and lower surfaces, and tapering spanwise twist of a mean average of the spanwise chord distribution of the wingtip.

At step 706, the lifting surface with the elliptical tapered wingtip is formed by fabricating the wingtip from well-known materials such as fiberglass, carbon fiber, Kevlar, VECTRAN or other aerospace grade reinforcing fibers and plastics. The lifting surface can also be fabricated from metals such as aluminum, steel, stainless steel, titanium, or other aerospace grade metals, or a combination of composite and metal materials. Processes for fabricating the lifting surface can include molding, machining, additive manufacturing, or combination of these practices. Once the fabrication process of fabricating the lifting surface with the tapered wingtip of the present invention is completed, the lifting surface can be attached as a kit to older aircraft, or incorporated into the fuselageas part of a new aircraft design. Alternatively, the tapered wingtip 110 can be fabricated separately from the lifting surface and attached thereon in a well-known manner. The method 700 then proceeds to step 799, where the method 800 ends.

A comparison with respect to air flow at the wingtip of a wing of a horizontal stabilizer 110 with and without the tapered elliptical wingtip 120 of the present invention installed on an aircraft 100 can best be seen in the graphic images of FIGS. 8A-10B.

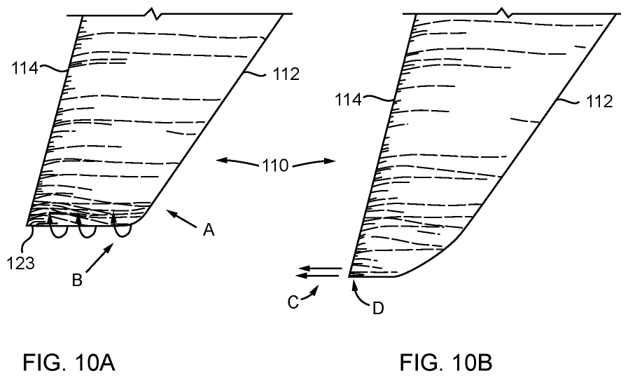

Referring now to FIGS. 8A-10B, representations of various views of screen shots of computer-simulated aircraft to illustrate comparative effects on airflow with and without the tapered elliptical wing tip 120 of the present invention mounted on the horizontal stabilizer 110 of an aircraft 100 are illustratively shown. FIGS. 8A and 9A are bottom, right-side views and FIG. 10A is a top right-side view of an unmodified horizontal stabilizer 110 without the tapered elliptical wing tip 120 of the present invention. FIGS. 8B and 9B are top, right-side views and FIG. 10B is a top, right-side view of the same horizontal stabilizer 110 being modified with the tapered elliptical wing tip 120. The drawings were taken from color-coded computer simulations which were configured and performed by the inventors using the well-known NASA “Common Resource Model” (CRM) from the 5th AIAA Drag Prediction Workshop, although such simulation program is not considered limiting. The simulations conducted were from an industry standard model of a 767/777/A330/A350 class aircraft. The CRM is used throughout the industry in wind tunnel and computational fluid dynamics (CFD) work to develop an understanding of drag and how to predict it. High surface pressure areas are illustrated by darker shading, as compared to low surface pressure areas which are illustrated by lighter shading at specific areas of the aircraft.

Referring to FIGS. 8A, 9A and 10A, during flight of the aircraft 100, the illustrative horizontal stabilizer 110 with the non-tapered wing tip induces wingtip vortices as illustrated by the concentration of curved streamlines as illustrated by arrow “A”. The horizontal stabilizer of a conventional commercial aircraft is designed to generate negative lift for purposes of stability. More specifically, the air above the horizontal stabilizer 110, which is at a high pressure/low velocity along the upper surface 124 of the wingtip 110, flows downwardly at the outermost end portion 123 of the wingtip 110 to the low pressure/high velocity lower surface 126 of the wingtip 110 in the form of a trailing or lift-induced vortex, as illustratively shown by the plurality of curved arrows identified by arrow “B”. The initiation of the wingtip vortex occurs at the outboard 5% of the leading edge of the combined horizontal stabilizer 110 and wingtip 120 (See arrow A of FIGS. 8A, 9A and 10A).

By contrast and referring to FIGS. 8B, 9B and 10B, the shape of the tapered elliptical wingtip 120 moves the initiation of the wingtip vortex to the most aft, outboard point on the wingtip 120, as illustrated by the plurality of arrows “C”. This is further evidenced by straight streamlines at the 99% to 100% span area of the combined wing and wingtip, as illustrated by arrow “D”. This outer and aft-most positioning of the wingtip vortex leads to lower induced drag, while the wingtip producing less lift on the wingtip than other designs provides for lower wing bending.

The inboard shift of the spanwise lift distribution leads to a lower bending moment on the wing structure. For a given lift condition, the reduction in bending moment increases the structural margin of the wing. The lower bending moment may allow an increase in the maximum gross weight capability of the aircraft with changes limited to the fuselage and landing gear systems. The design of the elliptical wingtip reducing lift at the wingtip also leads to a decrease in load on the OEM wingtip fasteners for retrofit applications. The existing fasteners, nut plates, and wingtip attachment can be retained in many cases. If needed, any additional structure required is far less than that required for other prior art wingtip devices.

Due to the increased inboard lift efficiency caused by the elliptical wingtip, the flight angle of, for example, the horizontal stabilizer will be reduced by approximately 0.2 degrees. Both manual and auto trim systems can accommodate this change without alteration to any indicator or control system. This difference in trim alpha will be nearly imperceptible to a flight crew.

Although an embodiment of the tapered elliptical wingtip 120 on a horizontal stabilizer 110 has been shown and described herein for mounting on an aircraft, such as the BOEING 737 model airframes (e.g., 737 NG-700 and the 737 MAX-7 airframes), such wingtip and airframe are described for illustrative purposes only, as a person of ordinary skill in the art will appreciate that the method 700 and tapered elliptical wingtip 120 of the present invention can be provided for any other aircraft or aeronautical vehicle having a lifting surface 110.

It is well known that each aircraft wing 102 (left and right, symmetrical about the long axis of the aircraft) generates a separate downwash sheet. The downwash sheets are virtually independent of each other due to the lateral separation created by the fuselage 101. The unique effect of the tapered elliptical wingtip 120 of the present invention is the more efficient extension of the left and right downwash sheets at the outermost edge of the wingtips and with greater lift distribution towards the inboard portion of the wings.

Another advantage is that the present tapered elliptical wingtip 120 can be implemented after the wing designs have been frozen or are already in production. For a newly designed aircraft, the tapered elliptical wingtip 120 can be iterative and be optimized with regard to the other components. A person of ordinary skill in the art will appreciate that other embodiments of the tapered elliptical wingtip 120 can be formed and positioned in a similar manner described above for various aircraft models.

While the foregoing is directed to embodiments of the present invention, other and further embodiments and advantages of the invention can be envisioned by those of ordinary skill in the art based on this description without departing from the basic scope of the invention, which is to be determined by the claims that follow.

What is claimed is:

1. A wingtip of an airfoil of an aircraft, the airfoil having a span, a leading edge, a trailing edge, an upper surface and a lower surface, the wingtip being in a range of five percent to fifteen percent of an end portion of the span of the airfoil, the wingtip comprising: an elliptical shape between the leading and trailing edges, the elliptical shape tapering in a direction towards an outer edge of the wing tip, wherein the tapering of the wingtip occurs in four geometric parameters including spanwise chord distribution between the leading and trailing edges, spanwise mean camber distribution between the leading and trailing edges, spanwise maximum thickness between the upper and lower surfaces, and spanwise twist of a mean average of the spanwise chord distribution of the wingtip; and
wherein the chord length is tapered in a range of 0.45 to 0.50 of the initial chord at 100% span, the mean camber distribution tapers to zero at 100% span, a thickness to chord ratio tapers to less than one percent at 100% span, and twist of a mean chord distribution of the span of the wingtip is in a range of negative one degree and negative three degrees at 100% span relative to the innermost airfoil of the wingtip in a direction of a positive lift axis.

2. A wingtip of a lifting surface of an aeronautical vehicle, the lifting surface having a span, a leading edge, a trailing edge, an upper surface and a lower surface, the wingtip being in a range of five percent to fifteen percent of an end portion of the span of the lifting surface, the wingtip comprising: an elliptical shape between the leading and trailing edges, the elliptical shape tapering in a direction towards an outer edge of the wing tip, wherein the tapering occurs in a plurality of geometric parameters of the lifting surface including spanwise chord distribution between the leading and trailing edges, spanwise mean camber distribution between the leading and trailing edges, spanwise maximum thickness between the upper and lower surfaces, and spanwise twist of a mean average of the spanwise chord distribution of the wingtip.

3. The wingtip of claim 2, wherein the trailing edge of the lifting surface is constant.

4. The wingtip of claim 3, wherein the chord length is tapered in a range of 0.35 to 0.60 of the initial chord at 100% span.

5. The wingtip of claim 3, wherein the chord length is tapered in a range of 0.45 to 0.50 of the initial chord at 100% span.

6. The wingtip of claim 2, wherein the trailing edge of the lifting surface is tapered.

7. The wingtip of claim 6, wherein the chord length is tapered in a range of 0.35 to 0.60 of the initial chord at 100% span.

8. The wingtip of claim 6, wherein the chord length is tapered in a range of 0.45 to 0.50 of the initial chord at 100% span.

9. The wingtip of claim 2, wherein the mean camber distribution tapers to zero at 100% span.

10. The wingtip of claim 2, wherein a thickness to chord ratio tapers to less than one percent at 100% span.

11. The wingtip of claim 2, wherein the spanwise twist of a mean average of the spanwise chord distribution of the wingtip is in a range of negative one degree and negative three degrees at 100% span relative to the innermost airfoil of the wingtip in a direction of a positive lift axis.

12. The wingtip of claim 2 which is configured for installation on one of a BOEING model 737 NG-700, 737 NG-800, and 737 NG-900 aircraft.

13. The wingtip of claim 2 which is configured for installation on one of a BOEING model 737 MAX-7, 737 MAX-8, 737 MAX-9, and 737 MAX-10 aircraft.

14. The wingtip of claim 2 which is configured for installation on a main wing of an aircraft.

15. The wingtip of claim 2 which is configured for installation on a horizontal stabilizer of an aircraft.

16. The wingtip of claim 2 which is configured for installation on a canard of an aircraft.

17. The wingtip of claim 2 which is configured for installation on rotor blade of a helicopter.

18. The wingtip of claim 2 which is configured for installation on a blade of a propeller.

19. A method of fabricating wingtip of a lifting surface of an aeronautical vehicle, the lifting surface including a span, and an elliptical shape defined by a leading edge, a trailing edge, an upper surface and a lower surface, the method comprising the steps of:
determining an outer portion of the lifting surface forming the wingtip;
tapering the elliptical shape of the wingtip in a direction towards a distal end of the wingtip, said tapering including:
tapering spanwise chord distribution between the leading and trailing edges,
tapering spanwise mean camber distribution between the leading and trailing edges,
tapering spanwise maximum thickness between the upper and lower surfaces,
tapering spanwise twist of a mean average of the spanwise chord distribution of the wingtip; and
forming the lifting surface with the elliptical tapered wingtip.

20. The method of claim 20, wherein the step of determining an outer portion of the lifting surface forming the wingtip comprises determining a proximal end and the distal end of the wingtip, wherein the proximal end being located at an outer five percent to fifteen percent of the span of the lifting surface.

21. The method of claim 20, further comprising maintaining the trailing edge of the lifting surface constant.

22. The method of claim 22, further comprising tapering the chord length in a range of 0.35 to 0.60 of the initial chord at 100% span.

23. The method of claim 22, further comprising tapering the chord length in a range of 0.45 to 0.50 of the initial chord at 100% span.

24. The method of claim 20, further comprising tapering the trailing edge of the lifting surface.

25. The method of claim 25, further comprising tapering the chord length in a range of 0.35 to 0.60 of the initial chord at 100% span.

26. The method of claim 25, further comprising tapering the chord length in a range of 0.45 to 0.50 of the initial chord at 100% span.

27. The method of claim 20, further comprising tapering the mean camber distribution to zero at 100% span.

28. The method of claim 20, further comprising tapering a thickness to chord ratio to less than one percent at 100% span.

29. The method of claim 20, further comprising tapering twist of a mean chord distribution of the span of the wingtip is in a range of negative one degree and negative three degrees at 100% span relative to the innermost airfoil of the wingtip in a direction of a positive lift axis.

30. The method of claim 20, further comprising configuring the lifting surface with the tapered wingtip for installation on one of a BOEING model 737 NG-700, 737 NG-800, and 737 NG-900 aircraft.

31. The method of claim 20, further comprising configuring the lifting surface with the tapered wingtip for installation on one of a BOEING model 737 MAX-7, 737 MAX-8, 737 MAX-9, and 737 MAX-10 aircraft.

32. The method of claim 20, further comprising configuring the lifting surface with the tapered wingtip for installation on a main wing of an aircraft.

33. The method of claim 20, further comprising configuring the lifting surface with the tapered wingtip for installation on a horizontal stabilizer of an aircraft.

34. The method of claim 20, further comprising configuring the lifting surface with the tapered wingtip for installation on a canard of an aircraft.

35. The method of claim 20, further comprising configuring the lifting surface with the tapered wingtip for installation on rotor blade of a helicopter.

36. The method of claim 20, further comprising configuring the lifting surface with the tapered wingtip for installation on a blade of a propeller.
